(19) United States
(12) Patent Application Publication
(10) Pub. No.: US 2025/0171335 A1
(43) Pub. Date: May 29, 2025

(54) WATER FLOATATION DEVICE FOR WATER REMEDIATION

(71) Applicant: OPENWATER.IN PVT. LTD., Bengaluru (IN)

(72) Inventors: Sanjiv SAMBANDAN, Bengaluru (IN); Arrshith RAMESH GANDHUDI, Bengaluru (IN); Navaneetha KRISHNAN, Bengaluru (IN)

(73) Assignee: OPENWATER.IN PVT. LTD., Bengaluru (IN)

(21) Appl. No.: 18/840,804

(22) PCT Filed: Feb. 7, 2023
(86) PCT No.: PCT/IN2023/050180

§ 371 Date: Aug. 22, 2024

(30) Foreign Application Priority Data
Feb. 25, 2022 (IN) 202241010094

(51) Int. Cl. C02F 1/461; B63B 22/16; C02F 103/00

(52) U.S. Cl. CPC C02F 1/46104; B63B 22/16; C02F 2103/007; C02F 2201/002; C02F 2201/009

(57) ABSTRACT

A water floatation device for water remediation of water body comprising an anchor connected to a buoy. The buoy includes a water remediation facilitator that is adapted to be connected to a solar panel, an antenna and a propeller (109) with a steering oar, plurality of water quality sensing sensors and a power adaptor. A cell is formed with at least two electrodes with intervening spaces between them and connected to the insulated proximal and distal end caps with perforations. The cell is electrically connected to the buoy. The water floatation device performs electrocoagulation and electro-oxidation of water and discharges the treated water back into the water body.

### TECHNICAL FIELD

The present invention relates to water floatation device to remediate water of a water body.

### BACKGROUND OF THE INVENTION

The treatment of large, polluted water bodies is essential for the environment and for sustaining communities that subsist on them as a source of water. These water bodies lakes, ponds, rivers and even large sewage treatment plants. Currently, treatment systems and methods involve the use of bio reactors or chemicals and these methods come with various degrees of problems.

Generally, chemicals such as alum are used to treat water bodies. Alum and equivalent chemicals are coagulants that lead to the clustering of impurities in water. However, such chemicals are inefficient due to firstly, a large quantity of alum is required in terms of weight to cluster a small quantity of pollutant and secondly, these chemicals are not easily recovered and need careful disposal.

### BRIEF DESCRIPTION OF THE DRAWINGS

FIG. 1 illustrates a perspective view of a water floatation device for remediation of water, with a cell having two cylindrical electrodes, deployed in a water body.

FIG. 2 is a partial sectional view of FIG. 1.

FIG. 3 illustrates a perspective view of a water floatation device for remediation of water, with a cell having three cylindrical electrodes, deployed in a water body.

FIG. 4 illustrates cross-sectional views of FIG. 3 with variable electrical connections.

FIG. 5 illustrates a perspective view of a water floatation device for remediation of water, with a cell having three cylindrical electrodes with grooves, deployed in a water body.

FIG. 6 illustrates a perspective view of a water floatation device for remediation of water with floating froth absorbers.

FIG. 7 illustrates a perspective view of a water floatation device for remediation of water with a sludge collector.

FIG. 8 illustrates a perspective view of the water floatation device for remediation of water with a modular cell arrangement.

FIG. 9 illustrates a perspective view of the water floatation device for remediation of water with parallel plate electrodes.

FIGS. 10(a) and (b) illustrate perspective views of the water floatation device for remediation of water with parallel plate electrodes depicting electrical connections.

FIG. 11 illustrates an arrangement of the cell inside the buoy of the water floatation device for remediation of water.

FIG. 12 illustrates a plurality of interconnected the water floatation devices for remediation of water, with individual units connected to a remote central hub for wireless communication.

FIG. 13 illustrates a plurality of interconnected the water floatation devices for remediation of water, with one unit connected to a remote central hub and others connected with relay connections, for wireless communication.

FIG. 14(a) to (h) depict images of exemplary water remediation using the water floatation device of the present invention.

FIG. 15 is a flow chart illustrating a method of water remediation using the water floatation devices of the present invention.

### OBJECTS OF THE PRESENT INVENTION

The primary object of the present invention is to provide a water floatation device for deployment in a water body, in a controlled manner, for water remediation, by detecting and treating the pollutants present in the water.

An object of the present invention is to provide a water floatation device with a cell connected to a buoy for performing electrocoagulation and electro-oxidation of water that is required to be remediated.

Another object of the present invention is to provide a water floatation device with a cell that is constructed with an electrode arrangement of at least two electrodes.

It is also an object of the present invention to provide a plurality of water floatation devices, to detect the quality of water and transmit the quality data, to an in-situ water remediation facilitator of the water floatation devices or to a central hub location, for data analysis, feedback and appropriate water remediation.

### SUMMARY OF THE INVENTION

Accordingly, the present invention provides a water floatation device for remediation of water of a water body comprising, an anchor connected to cell and a buoy. The cell is constructed with a suitable electrode arrangement for electrocoagulation and electrooxidation of water. The buoy includes sensors, a propellor, solar panel and an antenna. A water remediation facilitator is included in the buoy that is also connected to a remote central hub, to effect navigation of the water floatation device in water, receive and analyse quality parameters of water and perform water remediation, either in situ or through remote means. Plurality of water floatation devices are connected to remediate water of large water body.

### DETAILED DESCRIPTION OF THE INVENTION

The present invention provides a water floatation device for remediation of water of a water body that is configured to be deployed, in a controlled manner, in water, preferably in a large water body, for water remediation, by detecting and treating the pollutants present the water.

In the present invention, the term “water remediation” is to denote the treatment of water by separation of pollutants such that the bulk of the water is of better quality. The water quality should ideally be of discharge-level standards. The separated pollutants can be settled as sludge in the water body or floated up as froth. Other processes can be used to remove these from the water body. It is also possible to perform the separation in the water floatation device whereby all pollutants are contained in the water floatation device.

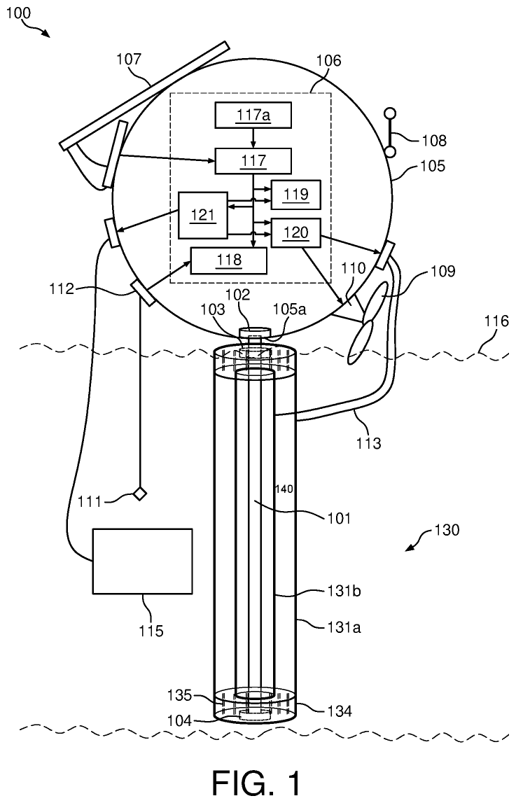

The preferred embodiments of the water floatation device of the present invention are now described by referring to the accompanied drawings. As shown in FIG. 1, the water floatation device (100) is constructed with an anchor (101), which is exemplarily shown as a rod-like or a shaft-like central structure, to which other primary components of the water floatation device (100) are connected. A buoy holder (102) is formed at one end (proximal end) of the anchor (101). The buoy holder (102) is provided with a suitable configuration, for instance a bolt-head like structure for holding a buoy (105) as hereinafter described. A proximal cell holder (103), which is advantageously provided with a holding structure, which is exemplarity shown as a circular structure, which is formed in proximity to the buoy holder (102), to hold one end of a cell (130). Similarly, a distal cell holder (104), having preferably, a reciprocal configuration proximal cell holder (103), is formed at the distal end of the anchor (101), as shown in FIG. 1. The arrangement of the buoy holder (102), proximal and distal cell holders (103, 104) is such that they are rotatable and movable along the central vertical axis of the anchor (101). The rotatable and movable buoy holder (102), proximal and distal cell holders (103, 104) primarily assist in tightly engaging the cell (130) with the buoy (105). The movable and rotatable engagement of the buoy holder (102), proximal and distal cell holders (103, 104) with the anchor (101), can be selected from suitable sliding and threaded mechanical engagements. The means for engagement of buoy holder (102), proximal and distal cell holders (103, 104) with the anchor (101) are also adapted for removal from and refitting with the anchor (101), as deemed necessary, to facilitate the assembly of cell (130) with the buoy (105), as detailed hereinafter. The shapes of the buoy holder (102), proximal and distal cell holders (103, 104) are exemplarily shown circular. However, it is understood that other suitable shapes, such as, non-circular holders can also be suitably adapted for use. Therefore, the anchor (101) with the buoy holder (102), proximal and distal cell holders (103, 104), forms a central axial structure to which buoy (105) and the cell (130) are connected such that the cell (130) is suspended from the buoy (105) and the buoy (105) floats on water during the deployment of the water floatation device (100).

The buoy (105), as shown in FIG. 1, is exemplarily shown as a hollow and round structure, which is preferably made from materials selected from high density polyethylene (HDPE) polyvinyl chloride (PVC), polystyrene, nylon and other suitable floatable materials, including metallic materials. The material for the buoy (105) can be made from such water proof materials, which can insulate and protect the modules (electronic components) that are stored inside from external environmental factors and hazards. The buoy (105) can be of any other suitable shapes such as sphere, torus etc., which can inter alia, enable the floatation of the water floatation device (100). The inner portion of the buoy (105) is used as a housing for arranging various modules of water mediation facilitator (106), preferably in tiered configuration. The various modules of the water mediation facilitator (106) are arranged inside the buoy (105) and the buoy (105) is sealed.

Now, the preferred embodiments of the water remediation facilitator (106) that is arranged inside the buoy (105) are described by referring to FIG. 1. The water remediation facilitator (106) comprises a controller module (121), which is a digital controller, a programmable logic controller or a processor with memory storage, that is adapted to control and execute various other modules that are connected to the water remediation facilitator (106) and drive other parts of the water floatation device (100) that are mounted on the buoy (105), for water remediation, in conjunction with the cell (130).

A power regulating module (117), a sensor module (118), a communication module (119) and a drive module (120), as shown in FIG. 1 are the other modules, which form the water remediation facilitator (106). These modules are the type, which can receive, store, process and transmit data, both internally among themselves and externally with other parts of the water flotation device (100), such as a solar panel (107), sensors (111), a propeller (109), an antenna (108) and peripheral electronics unit (115), that are mounted on and/or connected to the buoy (105). These modules and parts are configured to receive inputs, send data/information and act on the basis of digital and analogue signals.

The water remediation facilitator (106) is also arranged to connect, preferably through a wireless mode, with a remote operator or a central hub (154), for processing, data analysis and feedback, including actions that are required to be taken by the water floatation device (100) for water remediation.

The controller module (121), is the main processing module, which handles and regulates the various modules of the water remediation facilitator (106) and other defined parts that are connected to the buoy (105), including the cell (130). The controller module (121) is also adapted to transmit and share the processed information on water remediation across the various modules of the water remediation facilitator (106) and to the with a remote operator or a central hub (154). The communication module (119) is also adapted for a long-range wireless communication, including sending and receiving signals via the antenna (107) that is connected to the buoy (105). The sensed data are submitted to the communication module (119) by the sensor module (118) via the controller module (121). This information is sent by the communication module (119) to a cloud storage, Internet of Things (IoT) platform, or to an operator, or to any central data storage facility for further analysis. The communication module (119) is also adapted to receive signals from the operator concerning deployment, movement, and retrieval. The communication module (119) then passes the received information to controller module (121), which then instructs the propeller (109) to navigate the water floatation device (100) to the position as instructed by the operator.

The various modules of the water remediation facilitator (106) which is a digital controller, a programmable logic controller or a processor with memory storage, that are adapted to execute the designated functions and drive other connected parts of the water floatation device (100) that are mounted on the buoy (105), for water remediation, in conjunction with the controller module (121).

Therefore, the water remediation facilitator (106), along with its other modules are arranged inside the buoy (105).

Now, the other parts of the water floatation device (100), which are arranged or connected to an outer surface of the buoy (105) are described by referring to FIG. 1.

The solar panel (107) with an adaptor or a socket, is mounted on the buoy (105) and electrically connected to a power regulating module (117) and to the controller module (121), as renewable source of power. The solar panel can be made of suitable materials which are either rigid or flexible. A rechargeable battery pack (117a) is connected to the power regulating module (117). The power regulating module consists of circuits such as dc-dc converters, inverters and receives electrical power from the battery, solar panel or other energy harvesters and converts it to suitable voltage and current values as required by the various modules. The solar panel (107) is configured to harness solar energy and the corresponding converted power is then transmitted to the rechargeable battery pack (117a), through the power regulating module (117), for charging and re-charging the battery pack (117a), as needed. The battery pack (117a) thus receives power and supplies the power to the various other modules of the water remediation facilitator (106) and other parts of the water flotation device (100). The power regulating module (117) is also configured to receive power directly from the solar panel (107) and regulate this power and provide the electricity, at a preferred rated voltage and current, to the various other components and modules of water flotation device (100). Therefore, the power regulation module (117) is adapted to seek power from a solar panel (108), send it to the battery pack (117a) in a regulated manner and supply this power, at a rated voltage and current, to various other parts and modules that are presented in and connected to the buoy (105).

The antenna (108) is mounted on the buoy (105) and connected to the communication module (119), to act as a transceiver in handling data/information in the form of electromagnetic waves.

The propeller (109) with a steering oar (110) is connected to the drive module (120), for navigation and retrieval of the water flotation device (100) in and from the water body (116), in a controlled manner. Other suitable steerable water propulsion devices, preferably without gears and having a 360° manoeuvrability, can also be suitably adapted for use, in the water floatation device (100). The propeller (109) can also be an air propeller for navigating the water flotation device (100). It is also within purview of the invention, to use multiple propellers, at appropriate angles to each other, for instance at 120 degrees apart, for the navigation and retrieval of the water floatation device (100). Navigation can be performed by a GPS unit located in the controller module (121). The propeller (105) and the steering oar (106) are advantageously configured for wireless and/or wired remote navigation and retrieval of the water floatation device (100), while deployed in water, through the controller module (121), with a desired speed and velocity.

The sensors (111) that can measure various parameters concerning the quality of water in the water body (116) are connected to the buoy (105), through a connector or adaptor (112). The sensor module (118), which is positioned inside the buoy (105), is connected to the sensors (111), preferably through a wired arrangement and the connector (112) as shown in FIG. 1. The sensor module (118) is adapted to store data concerning the reference parameters of the desired values of water quality. The sensor module (118) is also adapted to receive electrical signals (voltage/current) from the sensors (111) concerning the various parameters of the water to be tested, which are used to compare with the stored reference values, in order to determine the status of quality of water in the water body (116). Therefore, the sensors (111) are adapted to sense various water parameters, such as pH, total dissolved solids (TDS), total suspended solids (TSS), biological oxygen demand, chemical oxygen demand etc. The sensed data on the quality of water are important both for the purpose of recording for analytics as well as to act as input to improve the treatment/remediation process. For instance, the sensed information based on the location of the mobile floatation device (100) can be used to map the pollutants in water. Such a map can also be used for calculation of gradients and performing other analysis etc. Further, the sensor information is used to identify the proper method to treat the water. For example, if the biological oxygen demand (BOD) is high, a larger power is used to drive an electro oxidation cell of the water flotation device (100). The sensors (111) send the sensed data to a sensor module (118). The sensor module (118) receives the signals from the sensors (111) and processes them to be readable by the controller module (121). This sensor module (118) therefore contains the instrumentation circuits to amplify and filter sensor data and then digitize them to appropriate voltage levels as required by the controller module (121). The sensor module (118) includes level shifters, choppers, instrumentation amplifiers, analog filters to filter noise, analog to digital converters and microcontrollers.

The controller module (121) that is arranged to receive to receive the digital signals from the sensor module (118) and act upon this information. The controller module (121) sends this information to the communication module (119) for further transmission. The controller module (121) uses the information received from the sensor module (118) to decide on the treatment process needed to achieve effective treatment of the water. The controller module (121) sends the appropriate signals to the drive module (120), which then drives the electrocoagulation cells. For example, based on the total suspended solid and BOD information received from the sensor module (118), the controller module (119) sets a desired drive current for the electro-coagulation and electro-oxidation by the electrode arrangement of the water floatation device (100) and this information is then communicated to the drive module (120), to drive the electrode arrangement. Thus, the drive module (120) takes power from the power regulating module (117) and drives the electrode arrangement (electro-coagulation and electro-oxidation cells). The power regulating module (117) includes voltage or current drive circuits components such as power transistors. Based on the signal received from the controller module (121), the drive module (120) sources the necessary voltage or current to drive the signal. In order to contain the heat dissipation in the drive module (120), an effective heat transfer elements such as fans and fins are adapted for use in the drive module (120).

The peripheral electronics unit (115) is connected to the buoy (105) as shown in FIG. 1. This unit includes storage tanks to store required chemicals for water remediation, such as a salt solution, an acid, a base etc. The unit (115) also includes a dosing pump and a fan. Based on the data as provided by sensors (111), the controller module (121) instructs the peripheral electronic unit (115) for dosing of chemical into the water body (116). For instance, in case a selected water body (116) has a low dissolved solid content and high BOD, the controller module (121) receives such an information from the sensor module (118) that is connected to the sensors (111), it recognises that the low conductivity of the water body would not result in an effective water remediation and the high BOD may not be able to be reduced, due to the low chlorine content in the water. The controller module (121) recognises these factors due to an inbuilt programming logic and preset thresholds of BOD and chlorine. In such a situation, the dosing pump in the peripheral electronics unit (115) is activated to dose sodium chloride solution in the water and then instructs the fan to mix it. In another instance, if the sensed information on the pH of the water is alkaline (say >8.5), the controller module (121) instructs the dosing pump to dose hydrochloric acid into the water body (116) in an attempt to neutralize the pH. The peripheral electronics unit (115) may also contain a ballast unit with an air compressor and pump. The controller module (121) is also adapted to fill the ballast with air or water to control the flotation depth of the water floatation device (100). Fan that is present in the peripheral electronics unit (115) is actuated by the controller module (121), to allow the water to flow locally thereby constantly letting in polluted water to be treated into the cell (130) and sending out treated water into the water body (116).

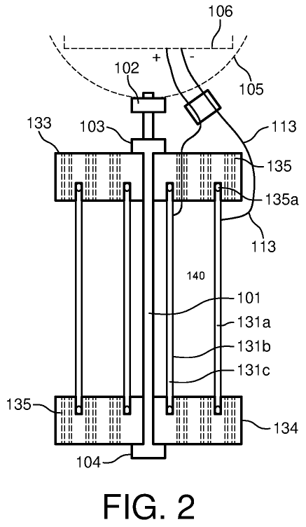

Now the preferred embodiments of a cell (130) of the water floatation device (100) and the interconnectivity between the buoy (5) and the cell (130), are now described, by particularly referring to FIGS. 1-4. As shown in FIG. 1, the cell (130) is constructed with two electrodes (131a, 131b) that are cylindrical and coaxial to each other and whereas in FIG. 2, the cell (130) is shown with an arrangement of three electrodes (131a, 131b, 131c) that are cylindrical and coaxial to one another. Therefore, a number of desired electrodes can be suitably adapted for use in the cell (130), for performing water remediation, considering of course the buoyancy of the water floatation device (100) in water.

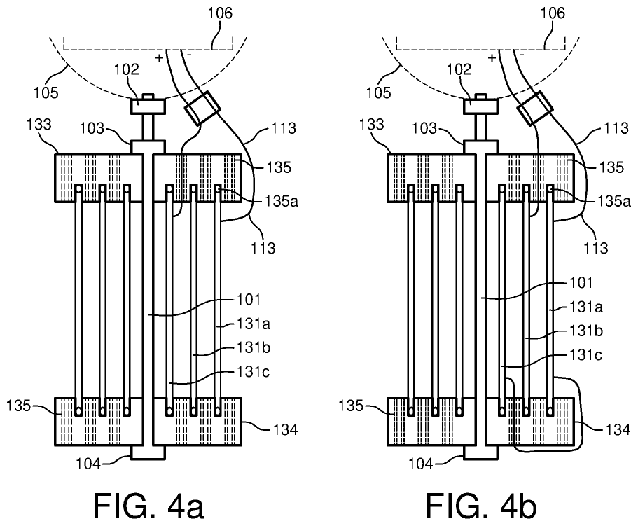

As an exemplary embodiment, the connectivity between the electrode arrangement and the buoy (105), is described reckoning the cell (130) with three electrodes, by particularly referring to FIG. 4, which can be followed for establishing the connectivity between the cell (130) with two electrode arrangement and the buoy (105).

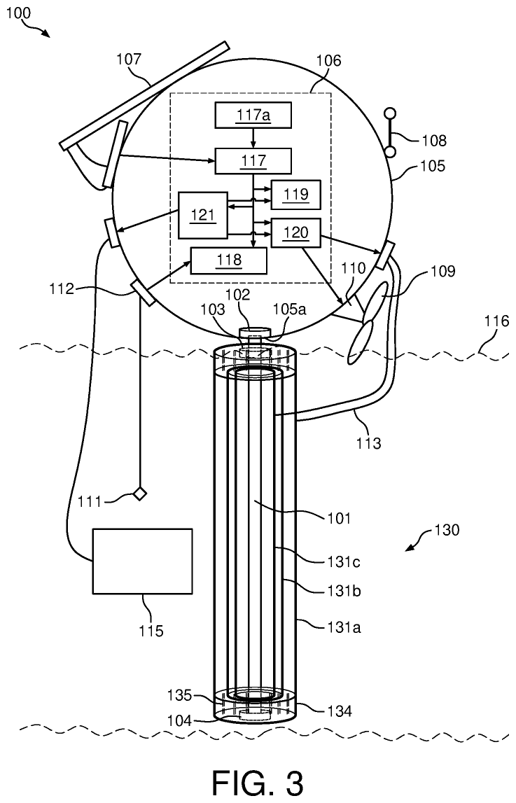

The electrode arrangement as shown in FIGS. 3-4, is provided with electrodes (131a, 131b, 131c) that are cylindrical and coaxial. The buoy (105) is connected the buoy holder (102) of the anchor (101), through an opening (105a) of the buoy (105). The opening (105a) is sealed once the buoy holder (102) is permitted inside the buoy (105), so as to particularly prevent leakage of water into the buoy (105), through the joined area between the buoy (105) and the buoy holder (102). The attachment or connectivity of the buoy holder (102) with the buoy (105) is established such that the anchor (101) stays suspended from the buoy (105), as shown in FIG. 3, when the water floatation device (100) is deployed in water.

A proximal end cap (133) is guided on the surface of the anchor (101), preferably from the distal end of the anchor (101) (after removing the distal cell holder (104) as deemed necessary) and abuttingly connected to the lower portion of the proximal cell holder (103), as shown in FIGS. 4(a) and (b). The abutting engagement of the proximal cell holder (103) with the proximal end cap (133) is suitably sealed to prevent a leakage of water.

Perforations or pores (135) are provided in proximal end cap (133) to permit the passage of water (116). Electrode grooves (139) are formed, preferably at the bottom portion of the proximal end cap (133) and lined with O-rings (135a). The electrode grooves (139) are formed with intervening distances among them.

The proximal terminal ends of the electrodes (131a, 131b, 131c) are inserted into the corresponding grooves (139) with O-rings (135a), such that the ends are fitted firmly into the grooves (139).

A distal end cap (134) with pores (135) and with reciprocal electrode grooves (139) and O-rings (135a), is guided on the surface of the anchor (101), from the distal end of the anchor (101) (after removing the distal cell holder (104) as deemed necessary). The distal ends of the electrodes (131a, 131b, 131c) are inserted into the electrode grooves (139) and O-rings (135a) of the distal end cap (134). The distal cell holder (104) is then connected to the anchor (101) and tightened suitably such that any existing air gaps among the electrodes, the end caps and cell holders are sealed appropriately. The O-rings (135a) are placed to provide good, water-tight engagement between the electrode arrangement ((electrodes (131a, 131b, 131c)) and the proximal and distal end caps (133, 134). Therefore, the arrangement of the proximal and distal cell holders (103, 104), facilitate fastening and tightening of the electrodes so as to achieve a good mechanical fit.

The proximal and distal end caps (133, 134) are made of electrically insulating material, preferably nylon.

Once the electrodes (131a, 131b, 131c) are fixed into the electrode grooves (139) the electrode arrangement will have intervening spaces (140) among them, which are used to permit the passage of water during water remediation.

The buoy (105) is connected the buoy holder (102) through an opening (103a) of the buoy (105), through which the buoy holder (102) is permitted to pass. The opening is sealed once the buoy holder (102) is permitted inside the buoy (105), such that inner portion of the buoy (105) is sealed in a manner to particularly prevent leakage of water into the buoy (105), from the joined area between the buoy (105) and the buoy holder (102).

The constructional arrangement of the buoy (105) and the cell (130), enables the stability of the water floatation device (100) not only when these are immersed in water (116) but also when the water floatation device (100) is navigated in water, due to their respective weights.

The buoy (105) is also electrically connected to the cell (130), through a wiring arrangement (113) and a socket (112) that is arranged on the buoy (105). This socket (112) is connected to the drive module (120) that is positioned inside the buoy (105). The electrical connectivity enables supply of power to the cell (130) for water remediation. In the case the cell (130) is provided with two cylindrical and coaxial electrodes (131a, 131b), one of the two electrodes acts as the cathode (−ve terminal, preferably the electrode with a larger diameter) and whereas the other electrode acts as the anode (+ve terminal). The electrodes (131a, 131b) are driven by either a constant current or a constant voltage as sourced by the power regulating module (117).

Alternately, for instance if the cell (130) is provided with two electrodes (131a, 131b), the inner electrode can also be electrically connected through the anchor (101). In such a case, an electrical connection between proximal cell holder (103) and the power regulating module (117) is established for driving the cell (130) (not shown in figures).

Therefore, the cell (130) of the water floatation device (100) can be provided with a plurality of cylindrical electrodes, for water remediation. In so far as electrical connections are concerned for the plurality of electrodes, they can either be driven serially or parallelly by a constant current or constant voltage drive. Advantageously, in case of a serial connection, the outermost electrode and the inner most electrode are connected to the drive module (120) and act as a cathode and an anode, respectively. In this arrangement, the current flows from the drive module (120) to the inner electrode, and to the intermediate electrodes through water. The current then flows to the outer electrode and back to the drive module (120). In case off parallel connection, every even electrode is shorted to each other and every odd electrode is shorted to each other. In this arrangement, two connections are drawn out of the odd and even electrode groups and are used and every odd electrode is shorted to each other and connections are drawn out. These two connections act as an anode and a cathode.

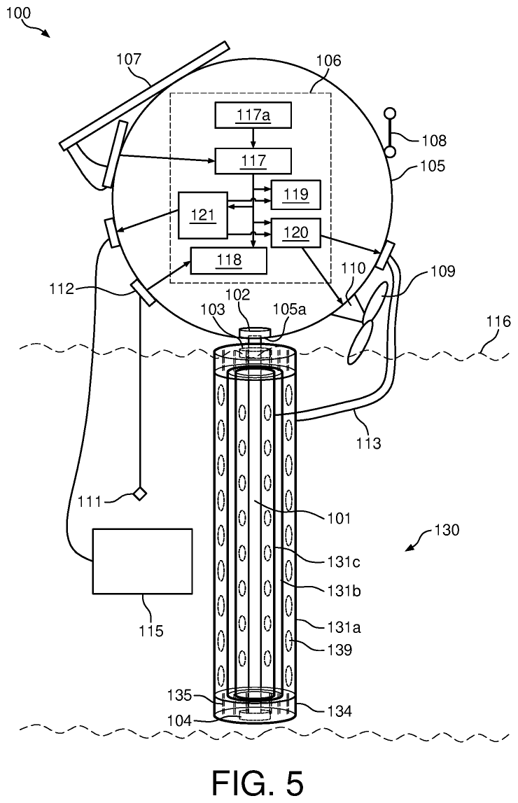

In another aspect of the present invention, as shown in FIG. 5, the electrodes (131a, 131b, 131c), where the electrodes are cylindrical and coaxial, the electrodes are perforated so as to permit the passage of water through these perforations for water remediation. Coaxial electrode arrangements permit a non-uniform electric field which permits more efficient treatment of water.

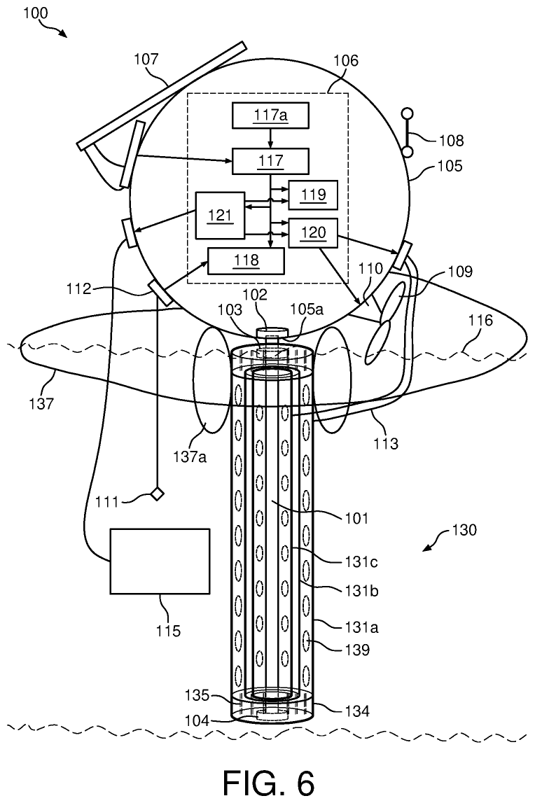

In yet another aspect of the present invention, as shown in FIG. 6, the froth (137) that is formed due to the release of hydrogen gas in the remediation process of pollutants that floats upwards as shown in FIG. 6, which is removed thereafter. To facilitate an easy collection and removal of the froth (137), a froth collection medium or froth absorber (137a), which is preferably a foam, is connected to the buoy (105) and the cell (130), with an adhesive (e.g. Velcro), to soak up or absorb the froth (137), that is formed on the surface of the water and around the cell (130) of water floatation device (100), as shown in FIG. 6.

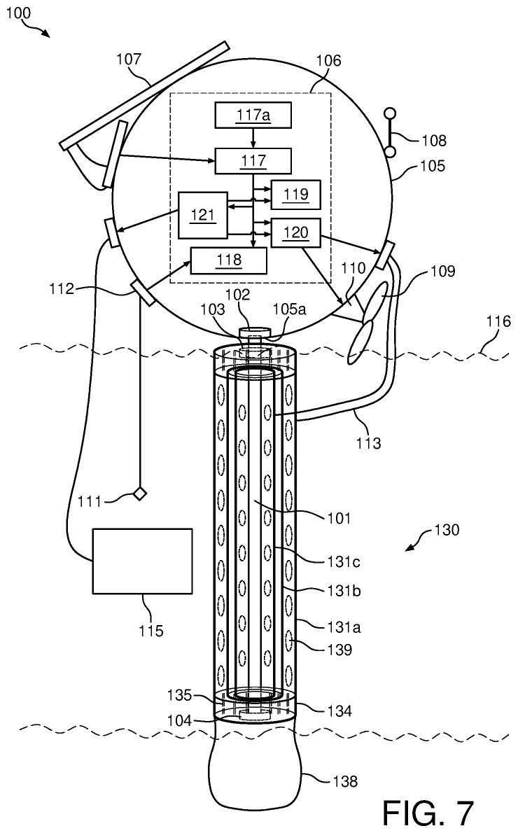

A sludge collection collector or bag (138) is connected to the bottom portion of the cell (130), preferably to the distal end cap (134), to collect sludge, which is released from the cell (130), during the course of water remediation, when a metal hydroxide coagulates the pollutants, as shown in FIG. 7. The collected sludge can be suitably collected from the bottom portion of the cell (130) and disposed as per the end user requirement.

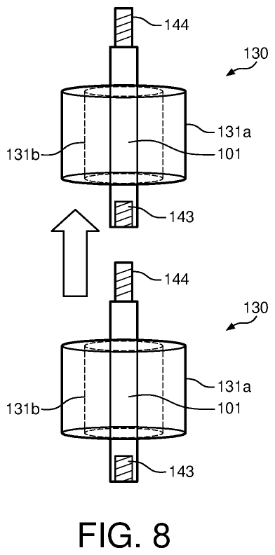

In another aspect of the present invention, in order to increase the length of the cell (130), thereby increasing its capacity of water remediation of the water floatation device (100), separate units of cells (130) are adapted to be connected together, as shown in FIG. 8. The connectivity among the different cells (130), as illustrated in FIG. 8, is exemplarily shown to be through a threaded arrangement, where proximal and distal cell holders of the individual cells are connected through male and female threaded arrangements (143, 144). It is also within the purview of this invention to use other engaging means such as sliders, rivets, cylinders, press-fit etc.

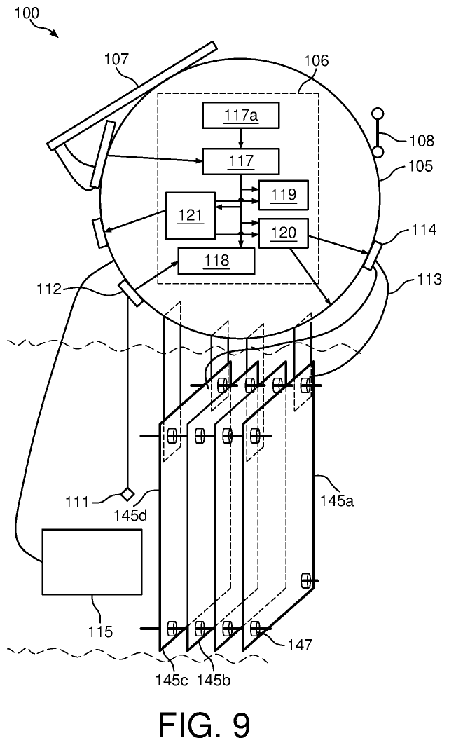

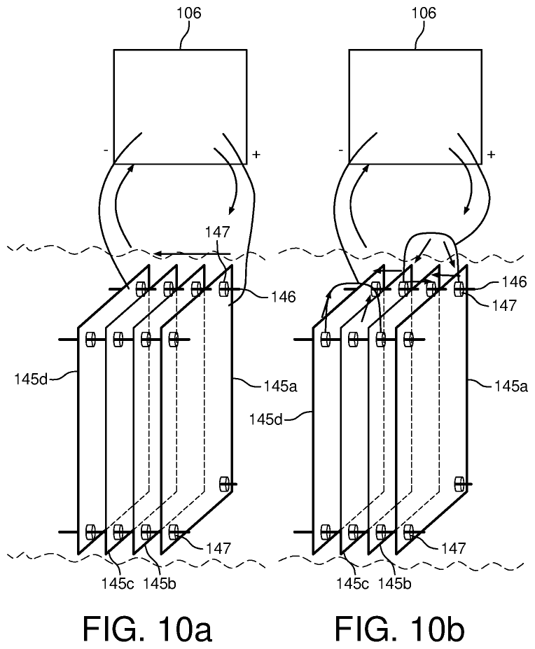

In an alternate embodiment, as shown in FIG. 9 the cell (130) is provided with vertically arranged parallel plate electrodes (145a, 145b, 145c, 145d) and the plate electrodes (145a, 145b, 145c, 145d) are held together by electrical insulating bolts (146), which are preferably made of nylon, running perpendicular to the face of the plate electrodes (145a, 145b, 145c, 145d). The nylon bolts have spacers (147) to define the gap between the plate electrodes (145a, 145b, 145c, 145d). The plate electrodes (145a, 145b, 145c, 145d) can be directly inserted into slots made in the buoy (105). These slots are then sealed to make the water floatation device water proof. Nylon bolts running perpendicular to the face of the plate electrodes (145a, 145b, 145c, 145d) can also be used inside water floatation device (100) to anchor the plate electrodes (145a, 145b, 145c, 145d) better. The electrical connections with the water remediation facilitator (106) of the buoy (105) are as shown in FIGS. 10(a) and (b).

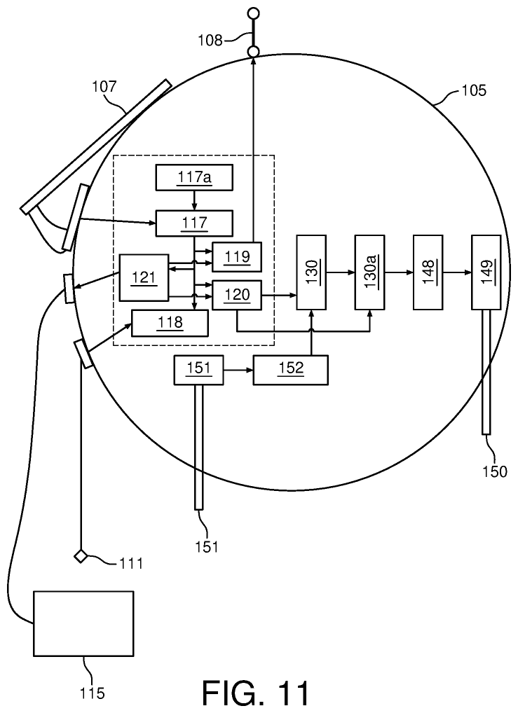

In another alternate embodiment, as shown in FIG. 11, the cell (130) is provided within the buoy (105) of the water floatation device (100), for water remediation. In other words, the cell (130) and the water remediation facilitator (106) are provided inside the buoy (105), such that the entire water remediation is undertaken inside the buoy (105). A water inlet (151) is connected to the buoy (105) to permit water from outside and is pumped into the cell (130), through a pump (153) and a dosing tank (152). A water separation unit (148) is connected to the cell (130) to permit water from the cell (130), to separate the clear water is separated from sludge and froth (137). The separation unit (148) can be a small centrifuge, a baffle, or a filter. A filtration unit (149) is connected to the water separation unit (148) for further filtration of the treated water and treated water is then allowed to flow back into the water body through an outlet (150). In the water remediation using the water floatation device (100) as shown in FIG. 10, the entire remediation process is undertaken inside the buoy (105). The inlet (151) and the outlet (150) are used to enable the water to flow in and out. The pump (153) that is arranged inside the buoy (105) sucks polluted water into the buoy (105) through the inlet pipe (151). The water is then fed into a cell (130) having cylindrical or parallel plate electrodes. Subsequent to the water remediation, the water is permitted to flow out of the cell (130) and to an electro-oxidation cell (130a), where water is further treated. Thereafter, the water flows into the water separation unit (148) where the clear water is separated from sludge and froth (137). The water is then further filtered and sent back into the water body through the outlet pipe (150). In the water floatation device (100) as shown in FIG. 11, the sludge and pollutants remain contained within the buoy (105). The buoy (105) is retrieved for disposal of the sludge and pollutants.

In the present invention, the selection of material for the electrodes of the water floatation device (100) is made considering the nature of pollutants in water. For instance, in order to treat suspended solids in water, the preferred material for electrodes (anode and cathode) can be made from aluminum, iron or steel. Whereas, in order to address the issue of biochemical oxygen demand (BOD) of water, the preferred material for the electrode (anode) is selected preferably from mixed metal oxides (MMO). It is also within the purview of this invention, to use a combination of electrode materials, for the electrodes of the cell, considering the nature of pollutants in the water.

Based on the materials used for the electrodes, the cells are referred to as electrocoagulation cells or electro-oxidation cells. For instance, in electrocoagulation cells, the anode and cathode electrodes are based on aluminum, iron or steel and whereas in electrooxidation cells, the anode is based on mixed metal oxides (MMO) and cathode is based on aluminum, steel or iron.

In water floatation device of the present invention, the electrodes can also be configured to have projections and/or indentations of various geometric patterns. The projections and/or indentations on the electrodes enhance the dielectrophoresis effect, improve the penetration depth of the electric field in the fluid and increase the surface area for electro coagulation.

In the event, where the size of the electrodes are required to be increased and larger electrodes are to be accommodated, the floor area of the buoy (105) and its height is to be suitably increased to ensure it floats. During this design, it must also be kept in mind that a larger battery pack (117a) is required to drive current through the larger electrodes. Accordingly, the following estimate is used to determine the size, weight of the electrodes and the batter pack (117a). If the area of the electrode is Aₑ and the thickness is tₑ, then the weight of the electrodes is NdₑAₑtₑ, where dₑ is the mass density of the material used for the electrodes and N the number of electrodes used. Accordingly, the weight of the buoy with the batteries, and all other electro-mechanical parts is W_{b}. Accordingly, the total weight of the water floatation device is W_{b}+dₑAₑtₑ. If the water floatation device is to sink a distance h into the water, the floor area of the pod is to be (W_{b}+NdₑAₑtₑ)/(hd_{w}), where the d_{w} is the density of water.

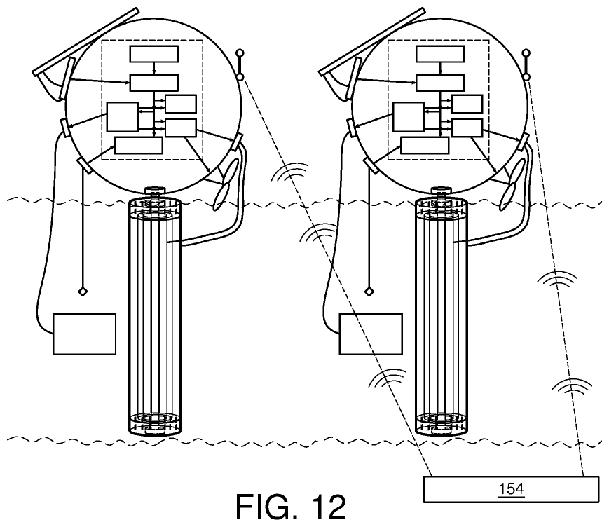

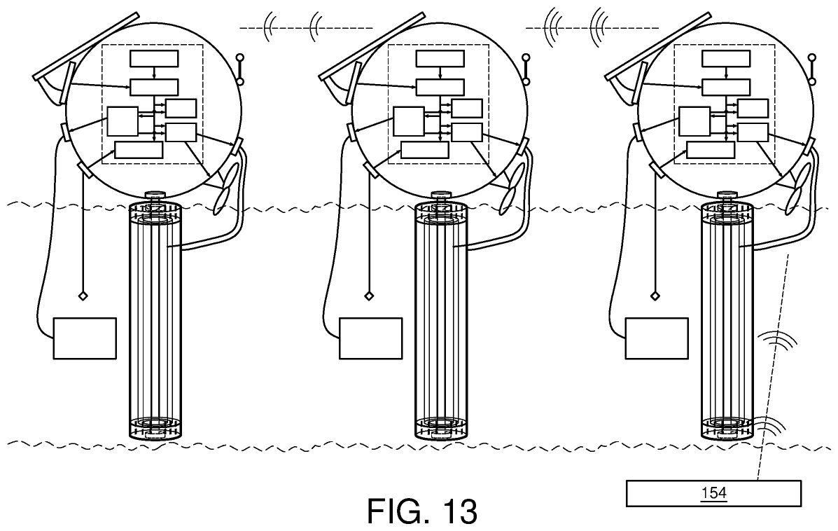

In yet another aspect of the present invention, in case of a need to treat water of larger water body, the plurality of water floatation devices (100) can be suitably deployed, in the water body, for the treatment of water, as shown in FIG. 12. Each of the water floatation device (100) can be deployed and used to remedy a small sector of water by area in the large water body. Communication to each of the plurality of floatation devices (100) can be individually established through an operator or central hub (154). Alternately, water floatation devices (100) can form a relay network, where the operator or the central hub communicates with few water floatation devices (100), which then relay the communication signals to all other water floatation devices (100), as shown in FIG. 13.

Accordingly, the water floatation device (100) for remediation of water of a water body comprises, the anchor (101) including the buoy holder (102), the proximal cell holder (103) and the distal cell holder (104). The buoy (105) that is connected to the anchor (101), through the buoy holder (102), includes the water remediation facilitator (106) that is adapted to be connected to the solar panel (107), the antenna (108) and the propeller (109) with the steering oar (110), plurality of water quality sensing sensors (111) and the power adaptor (112). The at least two electrodes (131a, 131b) with intervening spaces between them and with the anchor (101), are connected to the electrically insulated proximal and distal end caps (133, 134) that are defined by perforations (135) and which are mounted on the anchor (101), to form the cell (130). The cell (130) is adapted to establish an electrical connection with the water remediation facilitator (106). The buoy (105) is adapted to be controlled to float on water (116) and the cell (130) is adapted to suspend from the buoy (105) and submerge in the water (116).

The water remediation facilitator (106), includes a power regulating module (117) with a rechargeable battery pack (117a), which is adapted to be connected to the solar panel (107). The communication module (119) is adapted to be connected to the antenna (108). The sensor module (118) is adapted to be connected to the plurality of water quality sensing sensors (111). The drive module (120) is adapted to be connected to the propeller (109) and the steering oar (110), for driving and directing the water floatation device (100). The controller module (121) is adapted to be connected to the power regulating module (117), the communication module (119), the sensor module (118) and the drive module (120).

The peripheral electronics unit (115) of the water floatation device (100) is connected to the buoy (105).

The cell (130) of the device (100) includes at least three electrodes (131a, 131b, 131c) and are cylindrical. The electrodes are also in the form of parallel plate electrodes (145a, 145b, 145c, 145d).

In the water floatation device (100) the floating froth absorber (137a), preferably a sponge, is connected to the cell (130) and to the buoy (130), for absorbing the floating froth (137) and the sludge collector (138) is connected to the distal end cap (134), to collect the sludge from the cell (130).

In an aspect of the present invention the water remediation facilitator (106), the cell (130), the peripheral electronics unit (115), the oxidative cell (130a), the water separation unit (148), the filtration unit (149), are disposed inside the buoy (105) along with the water inlet (151) and the water outlet (150).

In yet another aspect of the present invention the plurality of flotation devices (100) are adapted to be connected for navigation and water remediation.

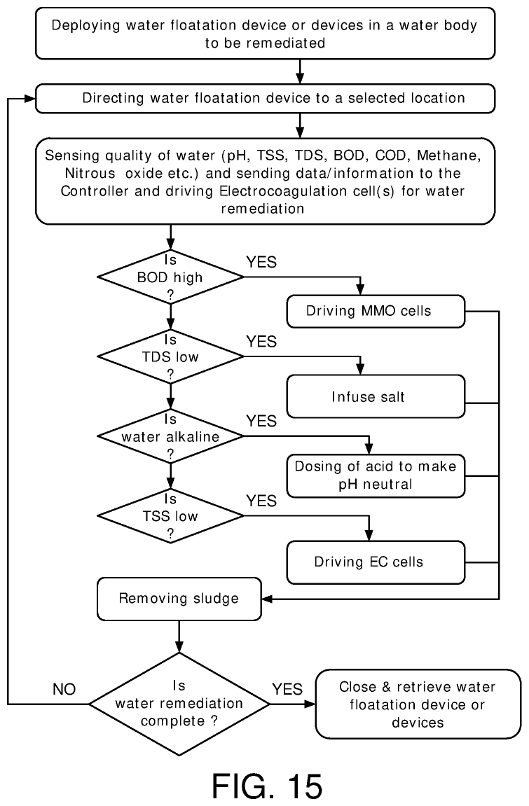

A process for remediation of water of water body using the floatation device (100) of the present invention is now described by referring to FIG. 15.

The process for remediation of water using the water floatation device of the present invention, is preferably performed through a process of electrocoagulation and electro-oxidation.

Initially, a required number of the water floatation devices for remediation of water are taken or transported to a selected water body location that needs to be remediated. The water floatation devices are deployed and dispersed through a remote control from a central hub, which can be a digital processor-based handheld device, a drone, a computer or any other suitable processing devices, in conjunction with the water remediation facilitators of the water floatation devices, in particular with the controller and communication modules. Thus the water floatation devices are deployed at a pre-determined location or locations. Each location is a part of a sector of the water body assigned to the water floatation device. The remote central hub sets the position of the water floatation device and velocity with which it has to navigate to that location. This information is relayed wirelessly to the water floatation devices through the controller module of the water floatation device. The controller module of each of the water floatation devices then commands the drive module to power the propeller and steering oar appropriately so as to navigate in the water body. Once the floatation devices are deployed at desired locations, the controller module uses position and acceleration sensors to keep the floatation device as stable in the water body as possible. Thereafter, water quality sensors sense the parameters of the water, such as pH, TSS, TDS, BOD, COD etc., and this information is sent to the controller modules of each of water floatation devices. The controller modules of the floatation devices send the water quality sensor information to the communication modules. The communication modules wirelessly transmit this information to the central hub. The controller modules of the floatation devices also use the water quality sensor information to decide on which water treatment electrocoagulation cells should be driven and how much salt is to be infused. For example, if BOD is high, the MMO cells will need to be driven. If TSS is high the EC cells need to be driven. If TDS is low, some salt will be infused in the water to improve conductivity and reduce power consumption. If the pH is high, some acid will be dosed. All or some combination of the above actions would be performed based on need. The controller module of particular water floatation device or devices also decides on how much power each electrocoagulation cell would be driven with. It then sends the appropriate commands to the drive module. The drive module drives the water electrocoagulation and electro-oxidation cells with the appropriate voltage or current.

In the water remediation process, the functioning of the method and components of the water floatation devices (e.g., electrocoagulation cells, sensors, sludge collection bags etc.,) are constantly monitored. The controller modules of the floatation devices and central hub are also configured to continuously receive sensor data for making appropriate decisions. On termination of the process steps, the floatation devices are retrieved. The central controller instructs the local controller to power the propeller and steering oar to make the floatation devices head towards a designated spot from which they can be retrieved.

The process of electrocoagulation using the water floatation device of the present invention, causes the metal ions to form hydroxides, thereby forming dense clusters with suspended solids, which to the bottom of the water body. Whereas, the production of hydrogen gas causes some of the pollutants to rise up as froth. The electrocoagulation can reduce total dissolved solids and turbidity from high values such as above 500 ppm to <1 ppm thereby meeting pollution control board standards. As an example, the use of electro-oxidation cells can result in the BOD and COD in the water reducing from 150 ppm and 350 ppm, respectively to <10 ppm and <40 ppm, respectively. The resulting water will have no odour. The presence of chlorine in the water is good for this process.

The process steps of water remediation using the water floatation device (100) of the present invention, are now described by using an illustrative example.

### Example

### Water Remediation Using the Water Floatation Device

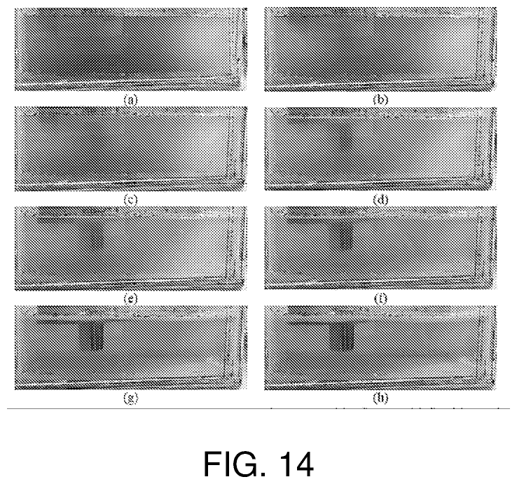

In this example, the water floatation device is used to treat a tank with 40 cm in height, 40 cm in width, 60 cm in length and with 50 liters of polluted water for water remediation. Parallel plate electrodes made of aluminum metal, with a bank of 4 electrodes are used, each having the geometry 4 cm by 10 cm and with a thickness of 5 mm. The four electrodes (electrode plates) are held together by nylon bolts and the spacing of 1 cm between the electrodes is defined by a nylon nut placed in the bolt and between two plates. The electro coagulation cell is connected to the buoy and the water floatation device is allowed to float on the water in the tank. The cell is driven by a constant current drive of 0.5 A with the electrodes in electrical series connection, i.e., the leftmost plate of the electrode and right most plate of the electrode are connected to the constant current source. This allowed a voltage of about 18 V to develop across the cells during treatment. During treatment, the application of the current resulted in an electrocoagulation process where in froth and sludge is generated. The sludge formation due to the formation of aluminum hydroxide results in the pollutants forming the sludge to sediment to the bottom of the tank. During water remediation, the concentration of the pollutants in the tank gradually become smaller and the water becomes clearer with time, as it can be seen in FIG. 14(a)-(h). The water is seen to be initially very turbid. With the water remediation, the sludge settles to the bottom of the tank while froth floats to the top. At first the water around the cells gets treated resulting in clear water around the cells. The pollutants from other parts of the tank begin to diffuse into the clear water and are immediately treated by the cells. This process continues till the entire water is treated. The water remediation in this example completed in about 2 hours.

### Advantages of the Present Invention

The device and method of the present invention, facilitate the remediation of water in large water bodies, without pumping out all the water or deploying large infrastructures in the water.

The remediation of water by the device and method of the present invention, is based on electrocoagulation and electrooxidation, which infuses the minimal material needed for treatment in the form of ions. Whereas, when chemicals are used for the treatment of treatment of water, only a portion of the chemicals i.e., the released ions are put to use and the rest of the chemicals pollute the water.

The water floatation device of the present invention, is configured to detect the quality of water and transmit the quality data, to an in-situ data analytic tool of the floatation device or to remote device or location for data analysis and feedback. The analysed data are used to identify the specific pollutants in the water and the floatation device is accordingly controlled to treat the water to remove the identified pollutants.

In the device of the present invention, the integration of mobility, sensing, IoT and treatment of water, enables the deployment of floatation devices in large numbers in water bodies, where the pollutants are larger, sparse and where pollutants are weaker. The IoT of the device helps with analytics in large water bodies, where a better sampling (more spatial resolution, over a larger space and desired depth) can be conducted by the mobile floatation devices.

The device and method of the present invention enables the treatment of water that is based on the sensing of pollutants, which can be vary from one spot to another. This variation pollutants as feedback from the sensors of the device, provides an invaluable input to regulate the various components of the device, in an effective manner.

1. A water floatation device for remediation of water of a water body, comprising:
(a) an anchor including a buoy holder (102), a
proximal cell holder (103) and a distal cell holder (104);
(b) a buoy connected to the anchor, through the buoy holder (102), including a water remediation facilitator that is adapted to be connected to a solar panel, an antenna and a propeller
(109) with a steering oar, plurality of water quality sensing sensors and a power adaptor;
(c) at least two electrodes with intervening spaces between them and with the anchor, are connected to electrically insulated proximal and distal end caps are defined by perforations and mounted on the anchor, to form a cell;
(d) the cell is adapted to establish an electrical connection with the water remediation facilitator; and
(e) the buoy is adapted to be controlled to float on water and the cell is adapted to suspend from the buoy and submerge in the water.

2. The water floatation device as claimed in claim 1, wherein the water remediation facilitator, includes
(a) a power regulating module with a rechargeable battery pack is adapted to be connected to the solar panel,
(b) a communication module is adapted to be connected to the antenna;
(c) a sensor module is adapted to be connected to the plurality of water quality sensing sensors,
(d) a drive module is adapted to be connected to the propeller and the steering oar, for driving and directing the water floatation device, and
(e) a controller module is adapted to be connected to
the power regulating module, the communication module, the sensor module and the drive module.

3. The water floatation device as claimed in claim 1, wherein a peripheral electronics unit is connected to the buoy.

4. The water floatation device as claimed in claim 1, wherein the cell includes at least three electrodes.

5. The water floatation device as claimed in claim 1, wherein the electrodes are cylindrical.

6. The water floatation device as claimed in claim 1, wherein the cell includes parallel plate electrodes.

7. The water floatation device as claimed in claim 1, wherein a floating froth absorber, preferably a sponge, is connected to the cell and to the buoy.

8. The water floatation device as claimed in claim 1, wherein a sludge collector is connected to the distal end cap.

9. The water floatation device as claimed in claim 1, wherein the water remediation facilitator, the cell, the peripheral electronics unit, an oxidative cell, a water separation unit, a filtration unit, are disposed inside the buoy along with a water inlet and a water outlet.

10. The water floatation device as claimed in claim 1, wherein the plurality of flotation devices are adapted to be connected for navigation and water remediation.

11. The water floatation device as claimed in claim 4,
wherein the electrodes are cylindrical.

12. The water floatation device as claimed in claim 10, wherein the plurality of flotation devices are adapted to be connected for navigation and water remediation.
